(19) United States
(12) Patent Application Publication
(10) Pub. No.: US 2024/0185055 A1
(43) Pub. Date: Jun. 6, 2024

(54) APPARATUS FOR ENHANCING LONGEVITY AND METHOD FOR ITS USE

(71) Applicant: Oceandrive Ventures, LLC, Rio Grande, PR (US)

(72) Inventor: Jeffrey Gladden MD FACC, Rio Grande, PR (US)

(73) Assignee: Oceandrive Ventures, LLC, Rio Grande, PR (US)

(21) Appl. No.: 18/073,022

(22) Filed: Dec. 1, 2022

(51) Int. Cl. G06N 3/08

(52) U.S. Cl. CPC G06N 3/08

(57) ABSTRACT

An apparatus for enhancing longevity, wherein the apparatus includes at least a processor and a memory communicatively connected to the processor, the memory containing instructions configuring the at least a processor to receive a baseline measurement for a user. Additionally, the memory containing instructions configuring the processor to compare the baseline measurement to a longevity enhancement threshold. The memory containing instructions further configuring the processor to generate a vitality enhancement program for the user as a function of the comparison of the baseline measurement and longevity the longevity enhancement threshold.

### FIELD OF THE INVENTION

The present invention generally relates to the field of health technologies. In particular, the present invention is directed to an apparatus for enhancing longevity and method for its use.

### BACKGROUND

Customized and up-to-date treatment protocol is necessary for extending the limit of human lifespan. Existing solutions are not satisfactory.

### SUMMARY OF THE DISCLOSURE

In an aspect, an apparatus for enhancing longevity, wherein the apparatus includes at least a processor and a memory communicatively connected to the processor, the memory containing instructions configuring the at least a processor to receive a baseline measurement for a user. Additionally, the memory containing instructions configuring the processor to compare the baseline measurement to a longevity enhancement threshold. The memory containing instructions further configuring the processor to generate a vitality enhancement program for the user as a function of the comparison of the baseline measurement and the longevity enhancement threshold.

In another aspect, a method for enhancing longevity is shown, the method includes receiving, using a processor, a baseline measurement for a user. Additionally, the processor compares the baseline measurement to a longevity enhancement threshold. Additionally, the processor generates a vitality enhancement program for the user as a function of the comparison of the baseline measurement and longevity enhancement threshold.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for enhancing longevity;

FIG. 2 is a block diagram of an exemplary machine-learning module;

FIG. 3 is a block diagram of an exemplary embodiment of a longevity database;

FIG. 4 is a diagram of an exemplary embodiment of neural network;

FIG. 5 is a diagram of an exemplary embodiment of a node of a neural network;

FIG. 6 is a flow diagram of an exemplary method of enhancing longevity;

FIG. 7 is a block diagram illustrating an exemplary embodiment of a plurality of systematic components for enhancing longevity; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for enhancing longevity. The apparatus may comprise at least a processor and a memory communicatively connected to the processor. The processor then may further be configured to receive a baseline measurement for a user. The processor then may compare the baseline measurement to a longevity enhancement threshold. A vitality enhancement program is then generated by the processor for the user. Exemplary embodiments illustrating aspects of the present disclosure are described below in the context of several specific examples.

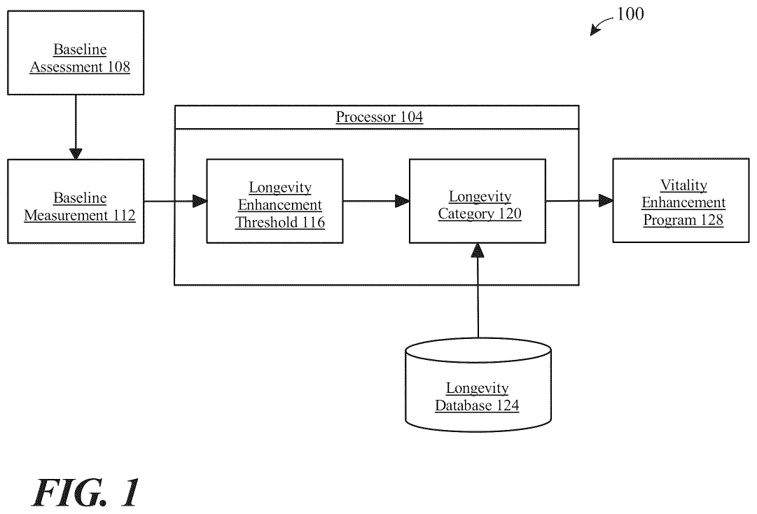

Referring now to FIG. 1, an exemplary embodiment of an apparatus 100 for enhancing longevity is illustrated. Apparatus 100 includes at least a processor 104. Processor 104 may be communicatively connected to a memory. As used in this disclosure, “communicatively connected” means connected by way of a connection, attachment or linkage between two or more related which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Continuing in reference to FIG. 1, processor 104 may receive, for a user, a baseline measurement 112. In some cases, user may be a patient. In other cases, user may be a medical professional. As used in this disclosure, “receive” from a user means accepting, collecting, or otherwise receiving input from a user and/or device. As used in this disclosure, a “baseline measurement,” is data that relates to the user's system or performance metrics. As used in this disclosure, “systems” are biological systems within a human body. In some cases, user's systems may include, but is not limited to, the circulatory, nervous, skeletal, respiratory, reproductive, endocrine, integumentary, renal, digestive, and muscular systems. Each organ may have one or more specialized role in the body and is made up of distinct tissues. In other cases, user's systems may include the heart, lungs, kidneys, or any other organ system. This may also include the components of a given system. In a non-limiting example, lungs may be component of the respiratory system. As used in this disclosure, “performance metrics” are numeric or linguistic measurement of the evaluation of the ability to perform one or more predetermined tasks. In some cases, predetermined task may include, but are not limited to, walking, running, squatting, jumping, lifting, sleeping, eating, thinking, learning, and the like. In an embodiment, baseline measurement may include information collected from a standard health screening. In some cases, standard health screening may include, but is not limited to, tests like blood test, hearing test, vision test, height, weight, and body mass index (BMI), and the like. In some embodiments, baseline measurement 112 may include information and/or measurement regarding to a bodily fluid of the user. As used in this disclosure, a “bodily fluid” is a liquid within the human body. In some cases, bodily fluid may include, but is not limited to, blood, saliva, urine, and the like. In some embodiments, baseline measurement may be received through an extraction device. As used in this disclosure, an “extraction device” is a device for extracting a first material from a second material. In some embodiments, extraction device may include, but is not limited to, needle, syringe, vail, and the like. In a non-limiting example, baseline measurement for the user may be received from blood drawn with needle. In other embodiment, baseline measurement 112 may include medical history, diet, exercise, sleep, time, and geographical location data of the user. Further, baseline measurement may be stored in a longevity database 124. In some cases, baseline measurement for the user may be retrieved from longevity database 124. Longevity database disclosed here will be described in further detail below.

With continued reference to FIG. 1, in some embodiments, receiving baseline measurement 112 may include receiving a baseline assessment 108. In some cases, baseline measurement 112 may be derived from baseline assessment 108. As used in this disclosure, a “baseline assessment” is an evaluation or estimation of baseline measurement 112. In some embodiments, without limitation, baseline assessment may include a set of questions, answered by patients. This may include, but is not limited to, questions about personal behaviors, risks, life-changing events, health goals and priorities, and overall physical and/or mental health of the user. In some embodiments, without limitation, baseline assessment 108 may also be a set of actions, performed by patients, that may include, but is not limited to, walking, running, squatting, jumping, lifting, sleeping, eating, thinking, learning, and the like. In an embodiment, 789 receiving baseline assessment 108 may further include receiving an initial baseline assessment and periodic repetition of baseline assessment. In some cases, periodic repetition may include, but are not limited to, hourly, daily, biweekly, weekly, bimonthly, monthly, yearly, and the like. In other cases, baseline assessment 108 may be stored in and/or retrieved from longevity database 124. Longevity database disclosed here will be described in further detail below. In some cases, baseline assessment 108 may include performing, without limitation, Neo 7 mTOR/AMPK, SASP Altered Intracellular Communication, Neo 7 Autophagy, Neo 7 Transcriptomics Proteome Autophagy, Life Length UCLA Immune Thymus MRI, Neo7 Stem cell status/exhaustion, Phenotypic evaluation, GTT with Insulin Curve Neo 7 mTOR/AMPK, Neo 7 Senescent Cell Burden and ASAP Beta Galactosidase, NADA and NADH Inflammatory Marker, Intrinsic and/or Extrinsic True Age/rate of aging, Inflammation Panel Neo 7, Neo 7 CPET, Neo 7 Transcriptomics, Glycation Age, Neo 7 CPET MitoSwab RMR Prodrome Scan NurEval, Thyroid panel and RMR, TZAR Test, RGCC General Testing, and the like thereof. Additionally, or alternatively, receiving baseline assessment 108 may include receiving baseline assessment 108 based on longevity category 120. Longevity category disclosed here will be described in further detail below. In a non-limiting example, for longevity category 120 of cancer risk mitigation, a baseline assessment 108 of TZAR test may be received in order to receive a baseline measurement 112 for cancer risk mitigation.

With continued reference to FIG. 1, baseline measurement 112 may include one or more measurable biomarkers. As used in the current disclosure, a “biomarker” is a biological molecule found in blood, other body fluids, or tissues that is a sign of a normal or abnormal process, or of a condition or disease. In some embodiments, biomarker may be used to see how well the body responds to a treatment for a disease or condition. In some cases, measurable biomarker may include, but is not limited to, yH2A.X immunohistochemistry, Leukocyte telomere length, MIR31HG, p16INK4a, Senescence-associated secretory phenotype (SASP) proteins, Measures of DNA methylation, SIRT1, SIRT2, SIRT3, SIRT6, SIRT7, Dosage of circulating microRNAs (miR-34a, MiR-21, miR-126-3p, miR-151a-3p, miR-181a-5p, miR-1248), P31 MRI spectroscopy, growth differentiating factor 15 (GDF15), Target of rapamycin (TOR), Protein carbonylation, Advanced glycation end products, Insulin-like growth factor (IGF-1), HGBA1c, IL-6, TNF-α, CRP (C-reactive protein), and TNFRII (tumor necrosis factor-α RII). Further, these biomarkers may be measured using various pathways including, but is not limited to, DNA repair mechanisms, DNA modifications, telomere length, markers of DNA damage response, telomerase activity, senescent markers in blood and tissue, DNA methylation, histone acetylation, noncoding RNA, autophagy markers, chaperon proteins, proliferative capacity in vitro, growth hormone axis, and metabolism alterations.

In an embodiment, baseline measurement 112 may include life energy testing. As used in this disclosure, a “life energy testing” is an evaluation of user's life energy measurement. As used in this disclosure, a “life energy measurement” is a biological measurement used to evaluate the life energy within the human body. As used this disclosure, “life energy” is a numeric measurement used to represent, measure, calculate, monitor, experiment, and/or evaluate the amount or level of the life energy flowing inside the energy meridian of a human or life body. As used in the current disclosure, “Life energy” is a form of energy related to one or more organs within a body of living organism. In some cases, organs may include, but are not limited to, the brain, lungs, liver, bladder, kidneys, heart, stomach, and intestines in the human body. The life energy measurement may also include an evaluation of the mental health status of a human or life. This may include an evaluation of the mental health of a human or life regarding overall energy, safety, wisdom, spiritual health, overall joy, relationship health, growth mindset, and overall mental health. In some cases, life energy testing may include, without limitation, evaluation of telomeres, mitochondria, proteomic measures and/or evaluations, glycans measures and/or evaluations, oncogenic measures and/or evaluations, determinations of epigenetic rates of aging, epigenetic urine measures and/or evaluations, DNA repair measures and/or evaluations, epigenetic intrinsic measures and/or evaluations, epigenetic extrinsic measures and/or evaluations, mTor AMPK balance measures and/or evaluations, NAD measures and/or evaluations, NADH measures and/or evaluations, determinations regarding prevalence, health or other qualities of stem cells, senescent cell burden measures and/or evaluations, senescent cell SASP measures and/or evaluations, immune system measures and/or evaluations, and/or inflammation measures and/or evaluations. In an embodiment, the calculation of the life energy measurement may encompass an evaluation from a mental health professional and user inputs. In another embodiment, the calculation of the life energy measurement may include a life energy comparison metric. A “life energy comparison metric,” as used in this disclosure, is a comparison of the user's current state of the life energy compared to the average or/and healthy state of the life energy of one or more similar situated (age, gender, weight, height, and the like) users.

With continued reference to FIG. 1, baseline measurement 112 may include a health measurement related to the user. As used in this disclosure, a “health measurement” is a comprehensive measurement related to the overall health status of the user. In some cases, health measurement may be generated as a function of the life energy measurement measured through life energy testing. In a non-limiting example, a 50-year-old user with a high life energy measurement, wherein the high life energy measurement may be equivalent to 25 years old. 50-year-old user may have a baseline measurement 112, wherein the baseline measurement 112 may include a health measurement of 25. In an embodiment, the health measurement may include, but is not limited to, the evaluation of the gender, weight, substance abuse, family health history, life energy, overall health, performance metrics and the like. In other embodiment, the health measurement may be measured using one or more patient specific metrics. A “patient specific metric” is specific performance metric based on the current physical or mental health condition of the user. The patient specific metric may include, but is not limited to, current sleep status, vascular and anatomic function, lung health, sex hormone balance, sexual function, brain function, brain anatomy, bone health, muscle function, joint function, ligament function, and tendon function. In other embodiment, the health measurement may also include evaluation of one or more lifestyle factor of a user. As used in this disclosure, a “lifestyle factor” is a personal and conscious decision to perform a behavior that may increase or decrease the risk of injury or disease, or/and the overall quality of life of a human being. In a non-limiting example, a healthy lifestyle factor may benefit both physically and mentally in everyday life of the user. The lifestyle factor may include, but is not limited to, exercising regularly, maintaining a healthy body weight, avoiding stationary sitting, avoiding sugar, eating more vegetables and fruits, drinking more water, going to bed early, quitting smoking and the like. In an embodiment, calculation of the health measurement may include a health measurement comparison metric. A “health measurement comparison metric,” as used in this disclosure, is a comparison of the user's current overall health status compared to the average or/and healthy overall health status of one or more similarly situated (age, gender, weight, height, and the like) users.

With continue reference to FIG. 1, the baseline measurement 112 may include a longevity measurement. As used in this disclosure, a “longevity measurement” is a biological measurement related to the user representing the length of the duration of maintaining user's health measurement. In an embodiment, longevity measurement may be the time from the users current age until system failure and/or death. In some cases, longevity measurement may be calculated as a function of health measurement and life energy measurement of the user. The longevity age may be determined by a rate of aging of the user. As used in this disclosure, a “rate of aging” is an indication of the rate of change of age as a function of the status of a given system. In some cases, rate of aging may be used to determine how quickly a given system is aging. In some cases, rate of aging may also apply to a given component of a system. In an embodiment, rate of aging may be reflected in terms of a ratio or a fraction. In a non-limiting example, a user with a high rate of aging may have a lower longevity measurement since the user may be aging quickly. In another non-limiting example, a user with a low rate of aging may have a higher longevity measurement since the user may be aging slowly. The difference between a first and a second baseline measurement 112 as numerator and the time between evaluations as denominator. Wherein the first baseline measurement (BM₁) is taken at the first evaluation and the second baseline measurement (BM₂) is taken at the second evaluation.

$$Rate of Aging = \frac{{BM}_{1} - {BM}_{2}}{Time between evaluations}$$

For example, a 25-year-old user's overall health status is similar to a 35-year-old on the first evaluation, therefore the user may have baseline measurement of 10. During the second evaluation, approximately 1 year later, the 25-year-old user may have overall health status similar to 40-year-old, therefore, the user may have baseline measurement of 15. The rate of aging of the 25-year-old user will be approximately −5. This may mean that the user's systems are aging at 5× the rate of a normal person. In reference to the rate of aging, a value ranging from −1 to 1 may be considered healthy. In an embodiment, the further the rate of aging is away from 0, the faster the user is aging either positively or negatively. Positive ageing is when the system is getting progressively healthier and thus more comparable to a younger person. Negative aging is when the system is getting progressively older and thus more comparable to an older person.

With continue reference on FIG. 1, baseline measurement 112 may include a performance measurement related to the user. As used in this disclosure, a “performance measurement” is a biological measurement that measures the user's ability to perform one or more predetermined tasks. In some cases, abilities that may be tested in evaluating a performance age of a user may include but not limited to the user's speed, flow state, agility, resilience, strength, reflection, both static and dynamic balance, recovery, flexibility, endurance, and the like. In an embodiment, performance measurement may be generated as a function of the longevity measurement. In a non-limiting example, a user with a high longevity measurement may have a high performance measurement since the user may have a longer duration of maintaining a health measurement. In another non-limiting example, a user with a low longevity measurement may have a low performance measurement since the user may have a shorter duration of maintain a health measurement. In another embodiment, performance measurement may include a performance measurement comparison metric. As used in this disclosure, a “performance measurement comparison metric” is a comparison of the user's current ability to perform one or more tasks compared to the average or/and expected ability to perform the same tasks of one or more similar situated (age, gender, weight, height, and the like) users.

With continued reference to FIG. 1, processor 104 may be configured to compare baseline measurement 112 to a longevity enhancement threshold 116. As used in this disclosure, a “longevity enhancement threshold” is a value related to the user's overall longevity. In an embodiment, longevity enhancement threshold 116 may indicate a balance point of baseline measurement of the user. In another embodiment, longevity enhancement threshold 116 may include one or more values and/or ranges of values relating to genomics, nutrigenomics, transcriptomics, proteomics, metabolomics, and the like. In some cases, longevity enhancement threshold 116 may include a plurality of longevity enhancement threshold. In some embodiment, longevity enhancement threshold 116 may be calculated as a function of life energy measurement, health measurement, longevity measurement, and performance measurement of baseline measurement of the user. In some embodiments, longevity enhancement threshold 116 may be calculated as a function of historical baseline measurements 112 of the users. In other embodiments, longevity enhancement threshold may also be calculated as a function a comparison of the user's one or more baseline measurement 112 with similar situated (age, gender, weight, height, and the like) users. Further longevity enhancement threshold 116 may be stored in longevity database 124. In some cases, longevity enhancement threshold may be retrieved from longevity database 124.

In some cases, the comparison of baseline measurement 112 and longevity enhancement threshold 116 may further identify a longevity improvement area. As used in this disclosure, a “longevity improvement area” is an area that can be improved regarding to user's overall longevity. In some embodiments, longevity improvement area may be a problematic area of the user. As used in this disclosure, a “problematic area” is an area associate with baseline measurement that is below longevity enhancement threshold. In an embodiment, problematic area of the user may be an aspect where user lack essential elements or/and need to be improved. In another embodiment, the problematic area may be an unhealthy system of the user. For example, an area x of the user that is currently evaluated through the baseline measurement 112 (BM_{current}), with measurements that are discovered to be less than the longevity enhancement threshold (θₗ) is determined as a problematic area.

∀x∈BM_{current}: x<θₗ

With continued reference to FIG. 1, comparing baseline measurement 112 to the longevity enhancement threshold 116 may further include using a machine-learning process trained with longevity training data, and classify baseline measurement 112 for the user to a longevity category 120 as a function of the trained machine-learning process. As used in this disclosure, a “longevity category” is biological category used to classify an area or field that affects the longevity of the user. In some embodiments, longevity category 120 may be stored in longevity database 124. In other embodiments, longevity category 120 may be retrieved from longevity database 124. In some embodiments, longevity category 120 may be related to, without limitation, genomics, nutrigenomics, transcriptomics, proteomics, metabolomics, life energy, longevity, health, performance, and the like. In some cases, longevity category 120 may include, without limitation, mTOR/AMPK, senescent cell cytokine burden, plasma restoration, AMPK/mTOR autophagy, AMPK/mTOR proteostasis, AMPK/mTOR mitophagy, AMPK activation, target tissues regeneration (i.e., joint, brain, and the like), hypothalamic STEM Cells rejuvenation, senolytic impact on senescent cell burden, DNA repair, DNA methylation, genetic expression, and the like thereof. Additionally, or alternatively, longevity category 120 may further include a longevity subcategory, wherein the longevity subcategory may include, but is not limited to, cancer risk mitigation, musculoskeletal healing, gut healing, organ healing, brain enhancement, peripheral neuropathy, long haul COVID, heart, lung, kidney, liver, pancreas, cosmetic, and/or the like. Longevity training data is a plurality of data entries containing a plurality of inputs that are correlated to a plurality of outputs for training a processor by a machine-learning process to align, classify, and determine longevity category to/of the user. In an embodiment, the inputs of the longevity training data may contain one or more baseline measurement 112 and enhancement threshold 116, and the outputs of the longevity training data may contain one or more longevity categories 116. In an embodiment, longevity training data may be retrieved from longevity database 124. In some embodiments, classifying baseline measurements 112 and enhancement threshold 116 to longevity category 120 may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, the processor 104 may be configured to generate a vitality enhancement program 128 as a function of the comparison of the baseline measurement 112 and longevity enhancement threshold 116. As used in this disclosure, a “vitality enhancement program,” as used in this disclosure, is a list of detailed descriptions or instructions that help to enhance the overall health of the user. In some cases, vitality enhancement program 128 may be generated as a function of longevity category 120. In an embodiment, vitality enhancement program 128 may include one or more therapies configured to strategically balance or/and improve the baseline measurement of the user. In some cases, therapy may include, but is not limited to, treatment involving apheresis, young plasma, telomerase, activated PRP/VSELS, rapamycin, dasatinib, quercetin, and the like. In other cases, vitality enhancement program may include one or more consumable ingredients, wherein one or more consumable ingredients are particular ingredient that has an effect on enhancing health and can be digested by user. In a non-limiting example, consumable ingredients may include, but is not limited to, vitamin D, Zinc, spermidine, hydroxyl berberine, rapamycin, metformin, pterostilbene, carnosine, curcumin, thyroid extract, and the like thereof. Consumable ingredients may further include a dosage, wherein the dosage is the size of a dose of consumable ingredient. For instance, dosage of Zinc may be 30 milligrams a day. In some embodiments, vitality enhancement program 128 may include a treatment schedule. As used in this disclosure, a “treatment schedule is a time schedule for performing prescribed treatment or therapy. In some cases, treatment schedule may include a course timing. “Course timing,” for the purposes of this disclosure, is the time user is to participate in enhancement program 128. In a non-limiting example, course timing may include a specific time and/or date that vitality enhancement program 128 is available for the user. In some cases, treatment schedule may include a treatment frequency. “Treatment frequency,” for the purposes of this disclosure, is a rate at which user is to participate in vitality enhancement program 128. In a non-limiting example, user may participate in vitality enhancement program 128 daily, weekly, bi-weekly, monthly, yearly, or the like thereof. In some cases, treatment schedule may include a treatment sequence. “Treatment sequence,” for the purposes of this disclosure, is an order of treatments in vitality enhancement program 128. In a non-limiting example, a first vitality enhancement program may be a prerequisite treatment for a second vitality enhancement program. In another embodiment, treatment schedule may include a treatment duration, wherein the treatment duration is a length of vitality enhancement program 128. In a non-limiting example, a vitality enhancement program 128 may include a treatment duration of 50 minutes. Vitality enhancement program 128 may include five treatments, each of which may be 10 minutes in length. In some cases, treatment schedule may include, but is not limited to, daily, weekly, bi-weekly, monthly, yearly, and the like. For instance, vitality enhancement program 128 may include a treatment at one or more frequencies, such as 3 times per day, 5 days per week. In other embodiments, generating vitality enhancement program 128 may include generating vitality enhancement program as a function of longevity category 120. In some cases, vitality enhancement program 128 may be tailored to longevity improvement area. In a non-limiting example, vitality enhancement program 128 may be focused on balance measurements within life energy category. In other cases, vitality enhancement program 128 may be tailored to the user based on baseline measurement and/or longevity enhancement threshold for the user. For another example, vitality enhancement program 128 may focus aspect where the baseline measurement does not meet longevity enhancement threshold of the user. Additionally, or alternatively, vitality enhancement program 128 may include a testing schedule, wherein the testing schedule is a time schedule for receiving baseline assessment 108. In some cases, testing schedule may include receiving baseline assessment 108 once per day, week, two weeks, month, two-month, quarter, six-month, year, and the like thereof. In some embodiments, vitality enhancement program 128 may be stored in longevity database 124. In other embodiments, vitality enhancement program 128 may be retrieved from longevity database 124.

With continued reference to FIG. 1, in some embodiments, generating vitality enhancement program 128 may include receiving an updated baseline measurement. As used in this disclosure, an “updated baseline measurement” is a baseline measurement received after receiving an updated baseline assessment, wherein the updated baseline assessment is a newly generated and received baseline assessment for a user. Updated baseline measurement may be any baseline measurement described in this disclosure. Updated baseline assessment may be any baseline assessment described in this disclosure. In some cases, updated baseline measurement/assessment may be different than baseline measurement/assessment. In other cases, updated baseline measurement/assessment may be same as baseline measurement/assessment. In some embodiments, generating vitality enhancement program 128 may include comparing updated baseline measurement to longevity threshold 116 and updating vitality enhancement program 128 as a function of the comparison of updated baseline measurement and longevity enhancement threshold. In some embodiments, updating vitality enhancement program may include updating, without limitation, descriptions/instructions, therapy, consumable ingredient, dosage, testing schedule, treatment schedule, and the like thereof. In a non-limiting example, processor 104 may receive a baseline measurement from a user, compare the baseline measurement to a longevity enhancement threshold and generate a vitality enhancement program of the user as a function of the comparison of baseline measurement to the longevity enhancement threshold. Vitality enhancement program may include a therapy of consuming 400 international units (IU) of vitamin D3 and vitamin D2 once per day. Processor 104 may receive an updated baseline measurement from user base on a testing schedule within vitality enhancement program, wherein the testing schedule may deliver an updated baseline assessment to processor 104 at certain time. Updated baseline measurement may be different than baseline measurement. Processor 104 may then compare updated baseline measurement to longevity enhancement threshold and update vitality enhancement program as a function of the comparison of the updated baseline measurement and longevity enhancement threshold. Vitality enhancement program may be updated in which it may include a therapy that increase dose of vitamin D3 and vitamin D2 if difference of updated baseline measurement and longevity enhancement threshold is greater than difference of baseline measurement and longevity enhancement threshold or decrease dose of vitamin D3 and vitamin D2 in another way around. Vitality enhancement program may be updated at any given time interval such as, without limitation, a given treatment schedule. Process of updating vitality enhancement program and/or any processing steps described in this disclosure may be performed, without limitation, at any given time interval.

With continued reference to FIG. 1, Processor 104 may generate vitality enhancement program 128 using a machine-learning process trained with vitality training data. Vitality training data is a plurality of data entries containing a plurality of inputs that are correlated to a plurality of outputs for training a processor by a machine-learning process to determine the vitality enhancement program for the user. In an embodiment, the inputs of the longevity training data may contain a plurality of baseline measurements and longevity enhancement thresholds, and the outputs of the vitality training data may contain a plurality of vitality enhancement programs. In some cases, compositional longevity training data may be obtained from longevity database 124. In some embodiments, compositional longevity training data may include manually labeled data. As a non-limiting example, baseline measurement 112 and/or vitality enhancement program 128 may be manually collected and labeled by the user and/or a medical professional. As a non-limiting example, a medical professional may receive examples of baseline measurement 112 and/or longevity enhancement threshold 116 and be asked to prescribe a vitality enhancement program 128; this dataset may then be used as vitality training data. In some embodiments, vitality training data may be derived from examples including a plurality of baseline measurement 118 and/or a plurality of longevity enhancement threshold. As a non-limiting example, vitality training data may be chosen from real-life examples of baseline measurements 112 and longevity enhancement threshold for patients and the associated vitality enhancement program of those patients.

Processor 104 may be designed and configured to create a machine-learning model using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm mounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

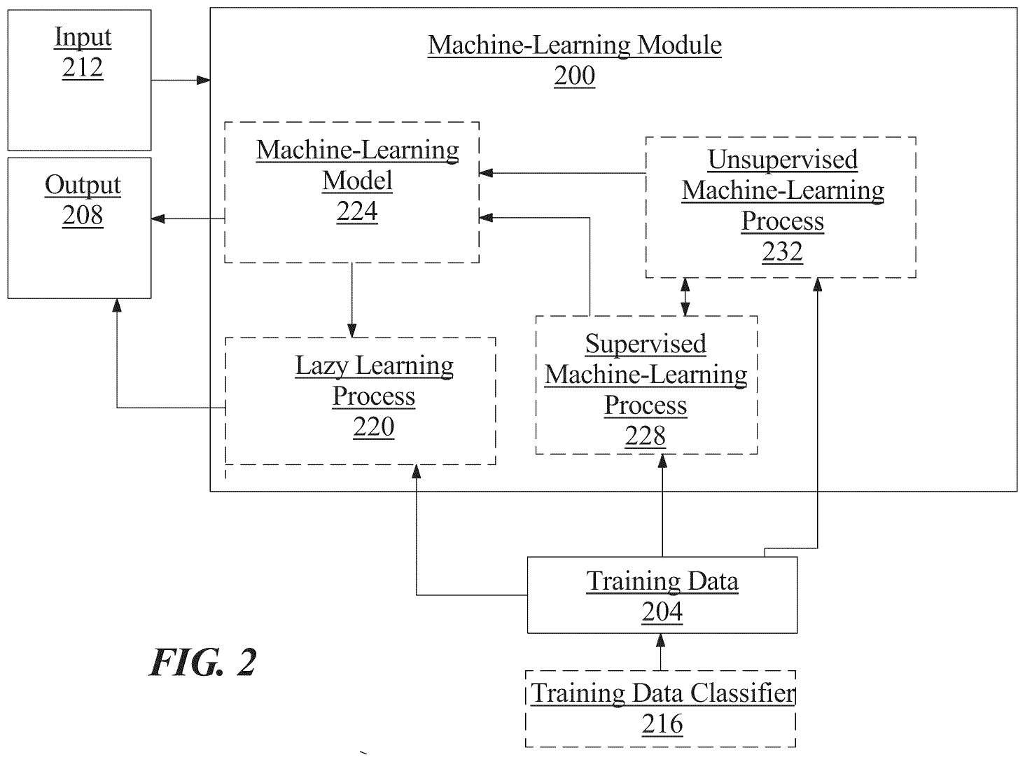

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs may include baseline measurement and/or longevity enhancement threshold and outputs may include longevity category. As another non-limiting example, inputs may include baseline measurement and/or longevity enhancement threshold and outputs may include vitality enhancement program.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to baseline measurement, longevity enhancement threshold, longevity category, and vitality enhancement program.

With continued reference to FIG. 2, A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Processor 104 and/or another device may generate a classifier using a classification algorithm, defined as a processes whereby a processor 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 2, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where a, is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described above in this disclosure as inputs, outputs as described above in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

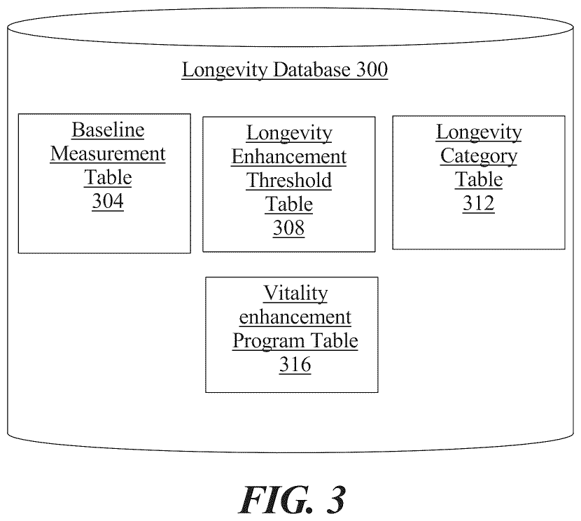

Referring now to FIG. 3, a non-limiting exemplary embodiment of a longevity database 300 is illustrated. Processor 104 may be communicatively connected with compositional longevity database 300. For example, in some cases, longevity database 300 may be local to processor 104. Alternatively, or additionally, in some cases, longevity database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 3, at least the processor 104 may, alternatively or additionally, store and/or retrieve data from a baseline measurement table 304, a longevity enhancement threshold table 308, a longevity category table 312, and a vitality enhancement program table 316. Determinations by a machine learning process may also be stored and/or retrieved from the nutrition database 300, for instance in non-limiting examples a misreporting factor. As a non-limiting example, longevity database 300 may organize data according to one or more longevity database 300 tables. One or more database tables may be linked to one another by, for instance in a non-limiting example, common column values. For instance, a common column between two tables of database may include an identifier of a submission, such as a form entry, textual submission, research paper, or the like, for instance as defined below; as a result, a query may be able to retrieve all rows from any table for a given submission or set thereof. Other columns may include any other category usable for organization or subdivision of expert data, including types of expert data, names and/or identifiers of experts submitting the data, times of submission, or the like; persons skilled in the art, upon reviewing the entirety of this disclosure, will be aware of various ways in which data from one or more tables may be linked and/or related to data in one or more other tables.

Still referring to FIG. 3, in a non-limiting embodiment, one or more longevity database tables of a database may include, as a non-limiting example, baseline measurement table 304, which may include baseline measurement for use in identifying baseline measurement for user and/or correlating biomarker data, entries indicating values and/or degrees of relevance to and/or efficacy in identifying baseline measurement for user, and/or other elements of data processor 104 and/or apparatus 100 may use to determine values and/or usefulness and/or relevance of biomarker data in identifying baseline measurements as described in this disclosure. In some embodiments, one or more baseline measurement tables 304 may correlate biomarker data and/or combinations thereof to one or more baseline measurements; baseline measurement table 304 may contain a plurality of entries associating at least an element of biomarker with baseline measurement. In other embodiments, one or more tables may contain one or more inputs identifying one or more categories of data, for instance demographic data, medical history data, physiological data, or the like. One or more tables may include longevity enhancement threshold table 308, which may contain one or more entries indicating longevity enhancement threshold for one or more user. One or more longevity enhancement threshold table 308 may correlate longevity enhancement threshold to one or more baseline measurements. In an embodiment, one or more longevity enhancement threshold table 308 may include longevity enhancement threshold use for identifying longevity category. In another embodiment, one or more longevity enhancement threshold table 308 may include longevity enhancement threshold use for generating vitality enhancement program. One or more tables may include, without limitation, longevity category table 312, which may include one or more entries describing the biological category regarding to enhancing longevity of user. In some cases, one or more longevity category table 312 may correlate one or more longevity categories to one or more vitality enhancement program. One or more tables may include, without limitation, vitality enhancement program table 316, which may include one or more entries describing vitality enhancement program of user. In some embodiments, one vitality enhancement program entry in enhancement plan table 316 may relate to a plurality of users. In other embodiments, one or more vitality enhancement program table 316 may correlate one or more vitality enhancement program to user's baseline measurements.

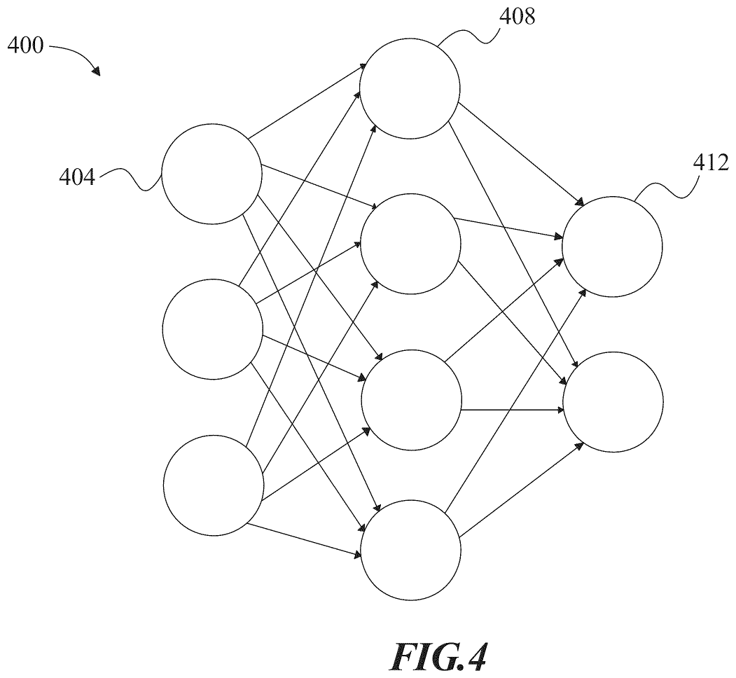

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

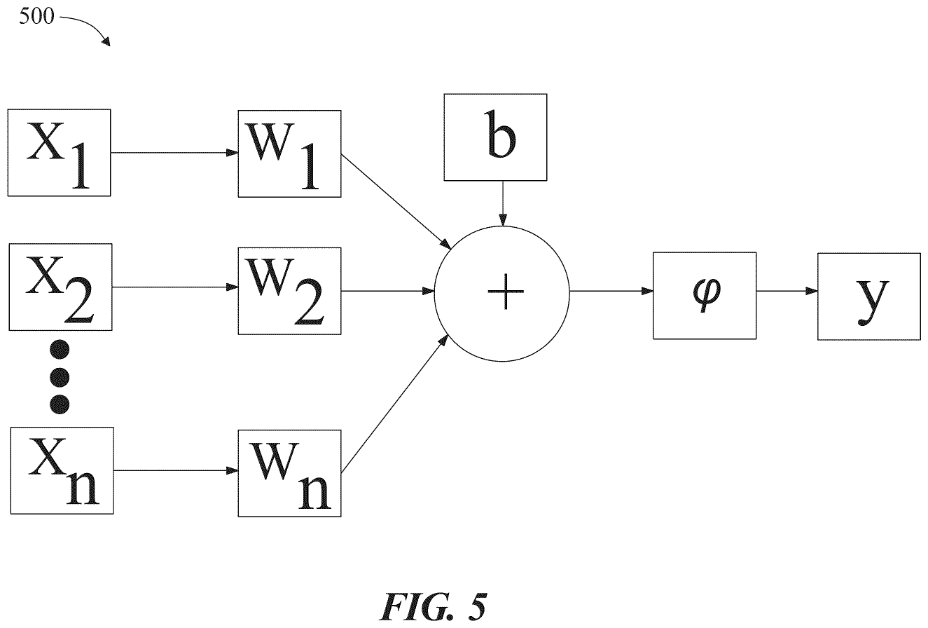

Referring now to FIG. 5, an exemplary embodiment of a node of a neural network is illustrated. A node may include, without limitation a plurality of inputs x, that may receive numerical values from inputs to a neural network containing the node and/or from other nodes. Node may perform a weighted sum of inputs using weights w′, that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ, applied to an input x, may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

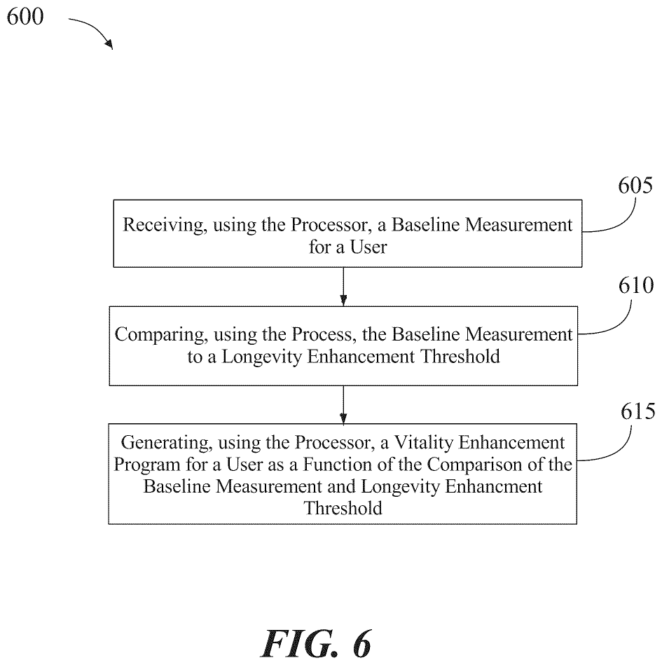

Referring now to FIG. 6, an exemplary method 600 for enhancing longevity is illustrated. Method 600 includes a step 605, of receiving, using a processor, a baseline measurement for a user, without limitation, as described above in reference to FIGS. 1-5. In an embodiment, baseline measurement may include biomarker associated with the user. In some cases, baseline measurement may include life energy measurement. In some cases, baseline measurement may include longevity health measurement. In some cases, baseline measurement may include longevity measurement. In some cases, baseline measurement may include performance measurement. This may be implemented, without limitation, as described above with reference to FIGS. 1-5.

With continued reference to FIG. 6, method 600 includes a step 610 of comparing, using the processor, baseline measurement to longevity enhancement threshold. This may be implemented, without limitation, as described above with reference to FIGS. 1-5. In some embodiments, comparing baseline measurement to longevity enhancement threshold may further include classifying baseline measurement to longevity category using trained machine-learning process. Machine-learning process may be trained using longevity training data, wherein the longevity training data contains plurality of inputs containing baseline measurements and/or longevity enhancement thresholds correlated to plurality of outputs containing longevity categories. This may be implemented, without limitation, as described above in reference to FIGS. 1-5. In some embodiments, comparison of baseline measurement and longevity enhancement threshold may further identify longevity improvement area. This may be implemented, without limitation, as described above in reference to FIGS. 1-5.

With continued reference to FIG. 6. Method 600 includes a step 615 of generating, using the processor, a vitality enhancement program the comparison of baseline measurement and longevity enhancement threshold. This may be implemented, without limitation, as described above with reference to FIGS. 1-5. In some embodiments, vitality enhancement program may include longevity subcategory. In some cases, generating vitality enhancement program may further including generating vitality enhancement program as a function of longevity categories. In other embodiments, generating vitality enhancement program may further including generating vitality enhancement program using trained machine-learning process. Machine-learning process may be trained using vitality training data, wherein the vitality training data contains plurality of inputs containing baseline measurements and/or longevity enhancement thresholds correlated to plurality of outputs containing longevity categories. This may be implemented, without limitation, as described above in reference to FIGS. 1-5.

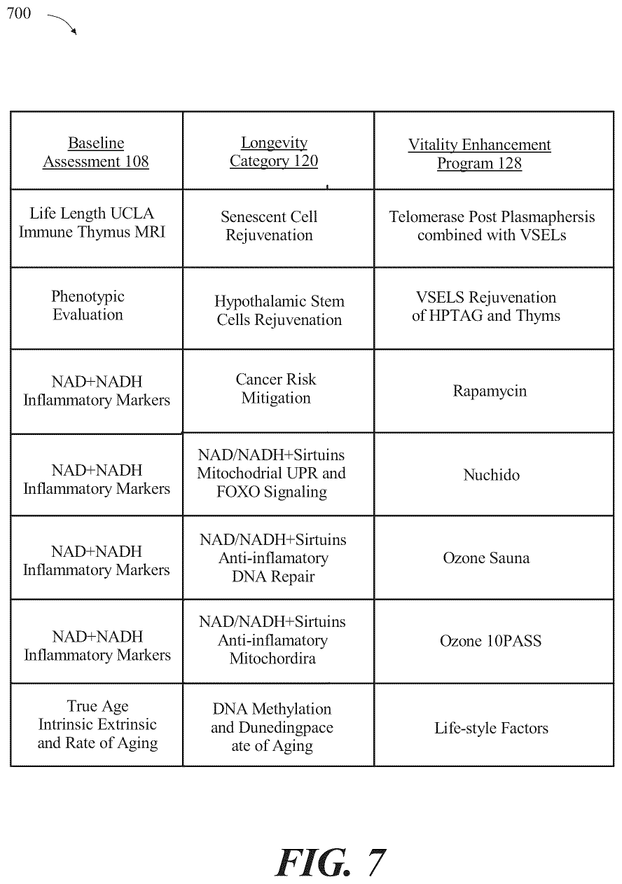

Now referring to FIG. 7, an exemplary embodiment of a plurality of systematic components 700 of apparatus 100 for enhancing longevity is illustrated. As used in this disclosure, a “systematic component” is a component of data which is essential for apparatus 100 for enhancing longevity. In some cases, plurality of systematic components 400 may include, without limitation, baseline assessment 108, baseline measurement 112, longevity enhancement threshold 116, longevity category 120, vitality enhancement program 128, and the like thereof. In some embodiments, without limitation, baseline assessment 108 may be any baseline assessment described above in reference to FIGS. 1-6. In some embodiments, without limitation, baseline measurement 112 may be any baseline measurement described above in reference to FIGS. 1-6. In some embodiments, without limitation, longevity enhancement threshold 116 may be any longevity enhancement threshold described above in reference to FIGS. 1-6. In some embodiments, without limitation, longevity category 120 may be any longevity category 120 described above in reference to FIGS. 1-6. In other embodiments, without limitation, vitality enhancement program 128 may be any vitality enhancement program described above in reference to FIGS. 1-6. Plurality of systematic components 400 may include a plurality of matching between baseline assessment 108, longevity category 120, and vitality enhancement program 128. In a non-limiting example, a vitality enhancement program may be selected based on a longevity category, wherein the longevity category may be classified as a function of a baseline assessment (i.e., baseline measurements).

With continued reference to FIG. 7, In a non-limiting example, processor 104 may receive a baseline measurement x for a user from a baseline assessment of Life Length UCLA Immune Thymus MRI. Processor 104 may then compare baseline measurement x to longevity enhancement threshold X and processor 104 may classify a longevity category of Senescent Cell Rejuvenation as a function of the comparison. Processor 104 may further generate a vitality enhancement program of Telomerase Post Plasmapheresis combined with VSELs for user. Vitality enhancement program may refine itself to Pre VSLs and Plasmapheresis with YP after 90 days as a function of an updated baseline assessment. In another non-limiting example, processor 104 may receive a baseline measurement y for a user from a baseline assessment of Phenotypic Evaluation. Processor 104 may then compare baseline measurement y to longevity enhancement threshold Y and processor 104 may classify a longevity category of Hypothalamic Stem Cells Rejuvenation as a function of the comparison. Processor 104 may further generate a vitality enhancement program of VSELs Rejuvenation of HPTAG and Thyms. Vitality enhancement program may include a first consumable ingredient of BPC 157 and a second consumable ingredient of COH. Vitality enhancement program may further include a treatment schedule for each consumable ingredient. First consumable ingredient may include a first treatment schedule of once per day and for 10 days. Second consumable ingredient may include one per day until next baseline assessment. Vitality enhancement program may further refine itself to 24 Hours Prior to Plasmapheresis with YP after 160 days as a function of an updated baseline assessment. In other non-limiting example, processor 104 may receive a baseline measurement z for a user from a baseline assessment of TZAR test. Processor 104 may then compare baseline measurement z to longevity enhancement threshold Z and processor 104 may classify a longevity category of Cancer risk mitigation as a function of the comparison. Processor 104 may further generate a vitality enhancement program, wherein the vitality enhancement program may include a consumable ingredient of rapamycin with a dosage of 2 milligrams. Vitality enhancement program may further include a treatment schedule of once per day.

With continued reference to FIG. 7, additionally, or alternatively, plurality of systematic components 700 may further include a match between baseline assessment including NAD+NADH Inflammatory Markers, baseline category of NAD/NADH+Sirtuins mitochondrial UPR and FOXO signaling, and vitality enhancement program of Nuchido. In some embodiments, plurality of systematic components 700 may further include a match between baseline assessment of NAD+NADH Inflammatory Markers, baseline category of NAD/NADH+Sirtuins Anti-inflammatory DNA repair, and vitality enhancement program of Ozone Sauna. In some embodiments, plurality of systematic components 700 may further include a match between baseline assessment including NAD+NADH Inflammatory Markers, baseline category of NAD/NADH+Sirtuins Anti-inflammatory Mitochondria, and vitality enhancement program of Ozone Sauna. In some embodiments, plurality of systematic components 700 may further include a match between baseline assessment of True age intrinsic extrinsic and rate of aging, longevity category of DNA methylation and dundingpace rate of aging, and vitality enhancement program of lifestyle factors.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

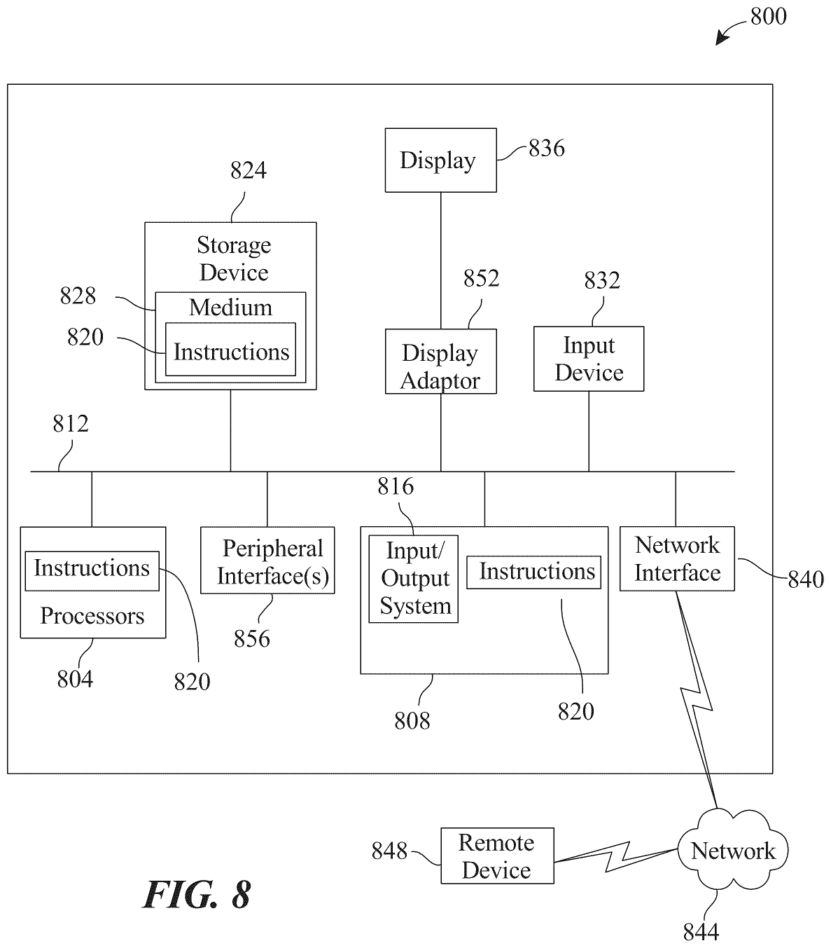

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for enhancing longevity, wherein the apparatus comprises:
at least a processor; and
a memory communicatively connected to the at least a processor, the memory containing instructions configuring the at least a processor to:
receive a baseline measurement for a user, wherein the baseline measurement comprises a biomarker pathway measurement;
compare the baseline measurement to a longevity enhancement threshold; and
generate a vitality enhancement program for the user as a function of the comparison of the baseline measurement and the longevity enhancement threshold, wherein the vitality enhancement program comprises a treatment schedule and a plurality of vitality enhancement programs comprising:
a first vitality enhancement program comprising consuming a first consumable ingredient at a first frequency and a first duration; and
a second vitality enhancement program comprising consuming a second consumable ingredient at a second frequency and a second duration, wherein the first vitality enhancement program is a prerequisite treatment for the second vitality enhancement program, wherein the first consumable ingredient is different than the second consumable ingredient, and wherein the second duration is longer than the first duration.

2. The apparatus of claim 1, wherein the baseline measurement comprises an energy comparison metric based on an evaluation of telomere length.

3. The apparatus of claim 2, wherein the baseline measurement comprises comparison of telomere length based on the biomarker pathway measurement, wherein the comparison is between the telomere length of the user and an average value of telomere length for a person with a characteristic that corresponds to the user.

4. The apparatus of claim 1, wherein the baseline measurement comprises a longevity measurement.

5. The apparatus of claim 1, wherein the baseline measurement comprises a comparison between the user and an average value for a person with a characteristic that corresponds to the user.

6. The apparatus of claim 1, wherein the baseline measurement comprises a rate of aging comprising a numerical difference between a first baseline measurement and a second numerical measurement, wherein the numerical difference is divided by a time between the first baseline measurement and the second baseline measurement.

7. (canceled)

8. The apparatus of claim 1, wherein generating the vitality enhancement program for the user comprises generating the vitality enhancement program as a function of a plurality of longevity categories.

9. The apparatus of claim 1, wherein generating the vitality enhancement program further comprises:
training a machine-learning process using vitality training data, wherein vitality training data contains a plurality of inputs containing baseline measurements and longevity enhancement thresholds correlated with a plurality of outputs containing vitality enhancement programs; and
generating the vitality enhancement program for the user as a function of the trained machine-learning process.

10. The apparatus of claim 1, wherein generating the vitality enhancement program further comprises:
receiving an updated baseline measurement;
comparing the updated baseline measurement to the longevity threshold; and
updating the vitality enhancement program as a function of the comparison of the updated baseline measurement and the longevity enhancement threshold.

11. A method for enhancing longevity, wherein the method comprises:
receiving, using a processor, a baseline measurement for a user, wherein the baseline measurement comprises a biomarker pathway measurement;
comparing, using the processor, the baseline measurement to a longevity enhancement threshold; and
generating, using the processor, a vitality enhancement program for the user as a function of the comparison of the baseline measurement and the longevity enhancement threshold, wherein the vitality enhancement program comprises a treatment schedule and a plurality of vitality enhancement programs comprising:
a first vitality enhancement program comprising consuming a first consumable ingredient at a first frequency and a first duration; and
a second vitality enhancement program comprising consuming a second consumable ingredient at a second frequency and a second duration, wherein the first vitality enhancement program is a prerequisite treatment for the second vitality enhancement program, wherein the first consumable ingredient is different than the second consumable ingredient, and wherein the second duration is longer than the first duration.

12. The method of claim 11, wherein the baseline measurement comprises an energy comparison metric based on an evaluation of telomere length.

13. The method of claim 12, wherein the baseline measurement comprises a comparison of telomere length based on the biomarker pathway measurement, wherein the comparison is between the telomere length of the user and an average value of telomere length for a person with a characteristic that corresponds to the user.

14. The method of claim 11, wherein the baseline measurement comprises a longevity measurement.

15. The method of claim 11, wherein the baseline measurement comprises a comparison between the user and an average value for a person with a characteristic that corresponds to the user.

16. The method of claim 11, wherein the baseline measurement comprises a rate of aging comprising a numerical difference between a first baseline measurement and a second numerical measurement, wherein the numerical difference is divided by a time between measurements.

17. (canceled)

18. The method of claim 11, wherein generating the vitality enhancement program for the user comprises generating the vitality enhancement program as a function of a plurality of longevity categories.

19. The method of claim 11, wherein generating the vitality enhancement program further comprises:
training a machine-learning process using vitality training data, wherein vitality training data contains a plurality of inputs containing baseline measurements and longevity enhancement thresholds correlated with a plurality of outputs containing vitality enhancement programs; and
generating the vitality enhancement program for the user as a function of the trained machine-learning process.

20. The method of claim 11, wherein generating the vitality enhancement program further comprises:
receiving an updated baseline measurement;
comparing the updated baseline measurement to the longevity threshold; and
updating the vitality enhancement program as a function of the comparison of the updated baseline measurement and the longevity enhancement threshold.

21. The apparatus of claim 1, wherein:
the baseline measurement comprises a performance measurement of the user based on a static balance and a dynamic balance of the user; and
comparing the baseline measurement to the longevity enhancement threshold comprises classifying the longevity enhancement threshold to a performance category and calculating the longevity enhancement threshold as a function of the performance measurement of the user.

22. The method of claim 11, wherein:
the baseline measurement comprises a performance measurement of the user based on a static balance and a dynamic balance of the user; and
comparing the baseline measurement to the longevity enhancement threshold comprises classifying the longevity enhancement threshold to a performance category and calculating the longevity enhancement threshold as a function of the performance measurement of the user.
